(19) United States
(12) Patent Application Publication
(10) Pub. No.: US 2026/0360217 A1
(43) Pub. Date: Nov. 12, 2026

(54) GAMING ESTABLISHMENT MARKERS INITIATED INDEPENDENT OF A USER AND APPROVED BY THE USER

(71) Applicant: IGT, Las Vegas, NV (US)

(72) Inventors: Jeffery Shepherd, Reno, NV (US); Kevin Higgins, Reno, NV (US); Michael Hirsch, Henderson, NV (US)

(21) Appl. No.: 19/200,052

(22) Filed: May 6, 2025

(51) Int. Cl. G07F 17/32

(52) U.S. Cl. CPC G07F 17/3241

(57) ABSTRACT

Systems and methods that, responsive to a receipt, from a third-party device independent of any gaming establishment device associated with a user, of data associated with a request to draw an amount of funds against a gaming establishment marker associated with the user, communicate data associated with a security measure to a marker approval device associated with the user. The marker approval device operates independent of the processor and independent of the third-party device. Responsive to a satisfaction of the security measure at least partially based on an interaction, by the user, with the marker approval device, the systems and methods approve the request to draw the amount of funds against the gaming establishment marker, and cause the amount of funds to be made available to the user.

### BACKGROUND

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIG. 2 is an example configuration of the architecture of a plurality of different components of the system of the present disclosure operating together to enable the employment of a marker approval device in association with drawing an amount of funds against a gaming establishment marker.

FIG. 3 is an example configuration of the architecture of a plurality of different components of the system of the present disclosure operating together to enable the employment of a marker approval device in association with a request from a third-party to draw an amount of funds against a gaming establishment marker associated with a user.

### DETAILED DESCRIPTION

In various embodiments, responsive to a receipt, from a third-party device independent of any gaming establishment device associated with a user, of data associated with a request to draw an amount of funds against a gaming establishment marker associated with the user, the systems and methods of the present disclosure communicate data associated with a security measure to a marker approval device associated with the user. In these embodiments, the marker approval device operates independent of the processor and independent of the third-party device. Additionally and responsive to a satisfaction of the security measure at least partially based on an interaction, by the user, with the marker approval device, the systems and methods approve the request to draw the amount of funds against the gaming establishment marker, and cause the amount of funds to be made available to the user.

In certain embodiments, in association with an attempted activation of an amount of funds to be drawn against a gaming establishment marker, the system of the present disclosure utilizes a distinct marker approval device, such as a mobile device of a user, to receive an approval of the transaction. In these embodiments, following a gaming establishment credit system receiving a request to activate an amount of funds associated with a gaming establishment marker, the gaming establishment credit system operates with the marker approval device to potentially obtain an authorization from the user in association with the amount of funds. In such embodiments, the authorization is based on one or more security measures being satisfied at least partially in association with the maker approval device. In certain embodiments, if an authorization is obtained via the marker approval device operating independent of the gaming establishment credit system, the gaming establishment credit system proceeds with causing a direct transfer of an amount of funds to a gaming establishment device, such as an electronic gaming machine (“EGM”) or a gaming table component. In certain embodiments, if an authorization is obtained via the marker approval device operating independent of the gaming establishment credit system, the gaming establishment credit system proceeds with causing an indirect transfer by transferring funds from a gaming establishment credit system to a gaming establishment account associated with the user and maintained by a gaming establishment fund management system and then transferring of such funds from the gaming establishment account to the gaming establishment device.

In certain embodiments, the authorization of a requested activation of an amount of funds associated with a gaming establishment marker employs the marker approval device and a gaming establishment device where such funds are destined for. In these embodiments, a user engages with multiple devices to effectuate a secure transfer of funds from a gaming establishment credit system to a gaming establishment device. For example, following a user at an EGM requesting, via a user interface displayed by the EGM but controlled independent of the EGM, an amount of funds drawn against a gaming establishment marker, a component of the gaming establishment credit system communicates a one-time password to a mobile device of the user (i.e., the marker approval device). In this example, responsive to the user entering the one-time password into such a user interface, the gaming establishment credit system transfers (directly or indirectly through an intermediary gaming establishment account associated with the user) the requested amount of funds to a credit balance of the EGM.

In certain embodiments, the authorization of a requested activation of an amount of funds associated with a gaming establishment marker employs a marker approval device independent of a gaming establishment device where such funds are destined for. In these embodiments, following a request to activate an amount of funds at a gaming establishment device, a user engages with the marker approval device to effectuate a secure transfer of funds from a gaming establishment credit system to the gaming establishment device. For example, following a user at an EGM requesting, via a user interface displayed by the EGM but controlled independent of the EGM, an amount of funds drawn against a gaming establishment marker, a component of the gaming establishment credit system communicates an authorization request to a mobile device of the user (i.e., the marker approval device). In this example, responsive to the user's mobile device authenticating the user using one or more biometric authenticators, such as a facial recognition authenticator, the gaming establishment credit system transfers (directly or indirectly through an intermediary gaming establishment account associated with the user) the requested amount of funds to a credit balance of the EGM.

Accordingly, since in certain instances, funds from a gaming establishment marker are made available at a gaming establishment device independent of any interaction with gaming establishment personnel, the system of the present disclosure adds an additional layer of security to such access of gaming establishment markers by employing user authentications generated from an independently operating marker approval device, such as a user's mobile device. That is, to bolster security (previously, but no longer, provided by gaming establishment personnel) and enhance how users are authenticated in accessing one or more gaming establishment components, such as a component of a gaming establishment credit system, such gaming establishment components utilize data obtained from a mobile device, such as a one-time password communicated to a mobile device and/or biometric data captured from the mobile device. In such embodiments, this use of a mobile device (i.e., the marker approval device) to obtain data associated with a user in a relatively private setting (i.e., private interactions between the user and their mobile device) automates and secures the transactions previously accomplished, in a relatively public setting, by gaming establishment personnel interacting with the user. This configuration of utilizing a mobile device provides that certain transactions which occur in a gaming environment are authenticated and authorized by the intended users and thus are more secure (i.e., less susceptible to fraud and other malicious activities).

In certain embodiments, the authorization of a requested activation of an amount of funds associated with a gaming establishment marker employs a marker approval device and a third-party device, such as a gaming establishment personnel device. In these embodiments, following a request made at a gaming establishment personnel device to activate an amount of funds from a gaming establishment marker, a user engages with the marker approval device to effectuate securely obtaining the funds from a gaming establishment credit system. For example, following a user at a gaming table interfacing with gaming establishment personnel to request an amount of funds drawn against a gaming establishment marker, the gaming establishment personnel utilizes a gaming establishment workstation to request the amount of funds from the gaming establishment credit system. In this example, a component of the gaming establishment credit system communicates a limited duration approval request to a mobile device of the user (i.e., the marker approval device). Responsive to the user approving the request, such as signing for the marker via the mobile device, prior to an expiration of the limited duration, the gaming establishment credit system updates one or more databases to reflect the authorized marker transaction and instructs, via the gaming establishment personnel workstation, the gaming establishment personnel to issue a corresponding configuration of gaming chips to the user at the gaming table.

Accordingly, in view of certain security risks associated with a user accessing a gaming establishment marker with limited or no interaction with gaming establishment personnel to, amongst other actions, confirm the identity of the user and confirm the user wants to proceed with a transaction involving drawing funds against a gaming establishment marker, the system employs a distinct marker approval device (e.g., a mobile device), and in certain embodiments, the ability of the marker approval device to capture biometric data associated with a user, to introduce an additional layer of authentication to how a user interacts with one or more components of a gaming establishment credit system. That is, utilizing data obtained from a separate marker approval device, such as a limited duration approval and/or biometric data captured from the mobile device, enables the system to enhance security and ease of use in how users are identified and authenticated in accessing funds from a gaming establishment marker. When compared to certain authentication methods which rely on simply a username and password, employing such a distinct marker approval device (and zero, one or more limited duration approvals and/or biometric data obtained from that marker approval device) provides a relatively safer and more secure way to authenticate and authorize a gaming establishment credit transaction in a gaming environment.

Additionally, employing the marker approval device enables an electronic transfer of funds from a gaming establishment credit system directly or indirectly to a balance of a gaming establishment device (e.g., an EGM) without the use of cash and without losing any security functionality otherwise associated with gaming establishment markers. Put differently, since certain gaming establishment patrons are uncomfortable venturing into a gaming establishment with large amounts of cash, the system enables a user access to an amount of funds from a gaming establishment marker without the need to handle cash. Such a reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Moreover, by reducing the amount of cash transactions in a gaming establishment via enabling the use of gaming establishment markers while retaining security functionality through the employment of a separately operating marker approval device, the system reduces or eliminates human errors which often occur when gaming table chips, cash and/or cashless ticket vouchers are distributed at gaming establishment interfaces, such as casino desks in association with the activation of a gaming establishment marker. Specifically, eliminating gaming establishment personnel from distributing gaming table chips, cash and/or cashless ticket vouchers in association with the activation of a gaming establishment marker not only protects the user (if the gaming establishment personnel provides the gaming establishment patron a lower amount of gaming table chips, cash and/or a lower valued cashless ticket voucher than the patron deserves) but also protects the gaming establishment (if the gaming establishment personnel inadvertently or fraudulently provides the patron a higher amount of gaming table chips, cash and/or or a higher valued cashless ticket voucher than the patron deserves). As such, the system of the present disclosure provides an alternative, non-cash-based and non-ticket voucher-based option for a gaming establishment patron to safely access funds drawn from a gaming establishment marker at a gaming establishment device while minimizing (or eliminating) certain human errors.

In various embodiments, the present disclosure is directed to a system including or otherwise in communication with various components and/or sub-systems that operate together to authenticate a withdrawal of an amount of funds from a gaming establishment marker and cause a transfer of such funds from a gaming establishment credit system to a gaming establishment device, such as an EGM or a gaming table component (with or without the employment of a gaming establishment account) independent of any cash and independent of any cashless ticket vouchers (e.g., an anonymous bearer instrument associated with an amount of funds and redeemable for cash via a kiosk, a cashier and/or game play on a gaming establishment device). In these embodiments, the collection of components that are part of the system (or otherwise operate with one or more components of the system) facilitate the independent approval and access of funds from a gaming establishment credit system.

In certain embodiments, the system includes or is otherwise in communication with a gaming establishment fund management system including various sub-systems that are each associated with or otherwise maintain one or more electronic or virtual accounts. In these embodiments, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user individually and/or collectively form an enterprise account (i.e., an integrated gaming establishment fund management wallet) that the user may access to transfer funds and/or view balance information amongst the various accounts associated with or otherwise maintained for the user.

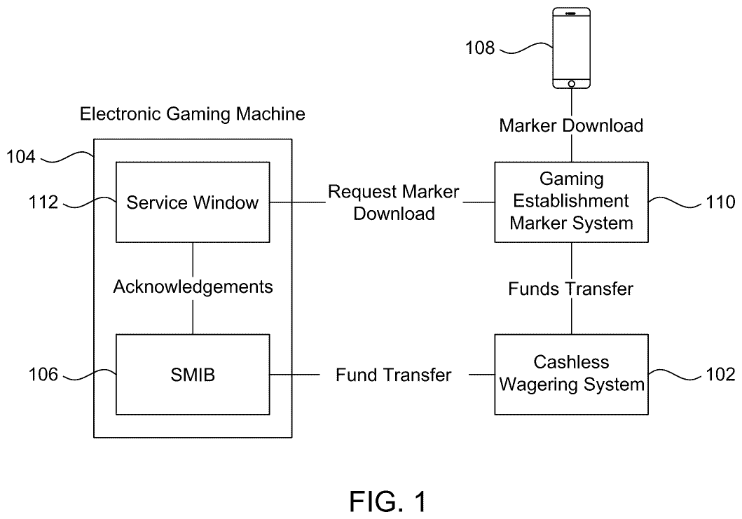

In certain embodiments, the gaming establishment fund management system includes or is otherwise associated with one or more cashless wagering systems that are each associated with or otherwise maintain one or more cashless wagering accounts. In certain such embodiments, the gaming establishment fund management system includes or is otherwise in communication with a cashless wagering system that maintains a cashless wagering account. For example, as seen in FIG. 1, the system includes a cashless wagering system 102 that maintains a cashless wagering wallet (e.g., a cashless wagering account). In this example, to facilitate the transfer of funds between this cashless wagering account and a credit balance of an EGM 104 and/or a credit balance of a gaming table component associated with a gaming table (not shown), the system utilizes a component of a gaming establishment management system (e.g., a slot machine interface board (“SMIB”) 106) supported by the EGM and/or a mobile device 108 running a mobile device application. In addition to the gaming establishment marker facilitated transfers of the present disclosure, these embodiments enable a user, such as a player at an EGM, to utilize a mobile device application running on a mobile device and/or utilize a physical instrument (e.g., a smart card or a user issued magnetic striped card which the user utilizes via inserting the card into a component of a gaming establishment patron management system associated with a gaming establishment device) to facilitate the electronic transfer of any funds between this cashless wagering account and a gaming establishment device, such as a component of a gaming table and/or the EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)).

In certain embodiments, the gaming establishment fund management system additionally or alternatively includes or is otherwise in communication with an additional or alternative cashless wagering system that maintains another cashless wagering account. In these embodiments, funds associated with this other cashless wagering account are utilized to place one or more sporting event wagers and/or wagers placed remote from an EGM and remote from a gaming table. In such embodiments and in addition to the gaming establishment marker facilitated transfers of the present disclosure, a user utilizes a mobile device application running on a mobile device and/or a physical instrument to facilitate the electronic transfer of any funds between this cashless wagering account and a credit balance accessible to wager on sporting events and/or games of chance (or games of skill) remote from an EGM and remote from a gaming table.

In certain embodiments, in addition to or an alternative of maintaining one or more cashless wagering accounts via one or more cashless wagering systems, the gaming establishment fund management system includes or is otherwise in communication with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, to facilitate the transfer of funds between this gaming establishment retail account and an account associated with a retailer to purchase goods and/or services from the retailer, the system utilizes a retail wallet identity, such as a mobile device running a mobile device application that interfaces with a point-of-sale terminal of a retail point-of-sale system of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

In certain embodiments, the system of the present disclosure includes or is otherwise in communication with one or more credit systems which each issue the user one or more gaming establishment markers drawn from one or more gaming establishment credit accounts. For example, as seen in FIG. 1, the cashless wagering system 102 that maintains a cashless wagering account is in communication with a gaming establishment credit system (i.e., the gaming establishment marker system 110) to facilitate the access of an amount of funds via one or more gaming establishment markers. These gaming establishment markers are accessible to facilitate a transfer of funds from the credit account (i.e., the line of credit) issued by the credit system to, either directly or indirectly through a cashless wagering account, a credit balance of a gaming establishment device, such as an EGM and/or a gaming table. In this example, to facilitate a transfer of funds against the gaming establishment marker issued by the credit system to a credit balance of an EGM 104 and/or a gaming table (not shown), the system utilizes a mobile device 108 (i.e., the marker approval device) running a mobile device application (i.e., a marker approval device application) that interfaces with one or more components of the credit system and, in at least this example, also utilizes a user interface displayed by the EGM but controlled separate from the EGM (i.e., service window 112) that also interfaces with one or more components of the credit system to enable a user, such as a player at the EGM or a player at the gaming table, access to such funds.

In certain embodiments, the system of the present disclosure includes or is otherwise in communication with one or more front money handling systems. In these embodiments, these front money handling systems each maintain an amount of front money provided by a user in a front money account. Such front money is provided by the user, such as via the user depositing cash, gaming table chips, a personal check, a bank draft, a money order or a wire transfer into a front money account associated with the user. The balance of the front money is drawn down from the front money account (in certain instances via the issuance of markers employing the marker approval device) and accessible by the front money handling system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal).

In certain embodiments, the system of the present disclosure includes or is otherwise in communication with one or more credit reporting/credit risk systems. In these embodiments, such credit reporting/credit risk symbols monitor and report on various accounts associated with the user. These credit reporting and risk systems monitor and report on a credit rating and status of one or more accounts maintained for the user at various funding sources, such as various financial institutions.

In certain embodiments, the system of the present disclosure includes or is otherwise in communication with one or more gaming establishment patron management systems, such as a player tracking system. In these embodiments, such gaming establishment patron management systems maintain data associated with one or more users, monitor activities at various points of contact associated with the gaming establishment and provides rewards, such as redeemable player tracking points, to such users in association with the monitored activities.

In various embodiments, the system of the present disclosure includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts).

In certain embodiments, the system utilizes one mobile device application operating as a marker approval device application to interact with the different components of (or in communication with) the gaming establishment fund management system to, amongst other actions, access funds maintained in (or accessible from) the different gaming establishment accounts associated with the user. For example, utilizing the same mobile application, a mobile device application operating as a marker approval device application interacts with both the cashless wagering system of the gaming establishment fund management system and the credit system. In certain embodiments, the system utilizes multiple mobile device applications to interact with the different components of (or in communication with) the system to, amongst other actions, borrow funds against a gaming establishment marker and/or access funds maintained in (or accessible from) the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the system enables a user to pair or link their mobile device to a gaming device, wherein this pairing or linkage between the mobile device and the gaming device occurs via one or more applications being run or executed on the mobile device. In certain such embodiments, the mobile device application prompts the user to cause the mobile device to engage the gaming device or a component of a gaming establishment management system supported by the gaming device (e.g., SMIB), such as prompting the user to tap the mobile device to a player tracking card reader or other designated location(s) of the gaming device. After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming device (or a component of the gaming device, such as a SMIB and/or the mobile device application) proceeds with operating with a component of (or in communication with) the system to log the user into an account maintained by that component (if necessary) and request authorization of the requested action.

In certain embodiments, two or more of the systems, sub-systems and components of the present disclosure may be combined into a single system, sub-system or component. For example, while the credit system and the credit risk system are described as separate components, the credit system and the credit risk system may be combined into a single component operable to interface with the cashless wagering system to facilitate the activation of a gaming establishment marker based on a credit worthiness of a user. It should be further appreciated that while described as funds activated from a gaming establishment marker being transferred (directly or indirectly through a gaming establishment account, such as a cashless wagering account) to an EGM, in different embodiments, funds activated from a gaming establishment marker may be transferred to any suitable non-EGM gaming establishment device operable to receive funds, such as, but not limited to, a kiosk or a retail point-of-sale terminal associated with a gaming establishment.

In certain embodiments, the system enables a transfer of funds between different accounts maintained by one or more gaming establishment components as well as activations of markers to enable different gaming activities and/or non-gaming activities. In these embodiments, the system employs a service for interfacing with the various components to facilitate balance inquiries and the transfer of funds. In certain embodiments, such a service collects data from various components and utilizes such collected data to provide a singular view of the balances (or a plurality of singular views of different groupings of balances) available. In certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, such a service additionally or alternatively tracks and coalesces transaction history of the interconnected components of the system such that all transactions within the system have a “master” transaction record that ties all of the various fund transfers to a single initiating funds transfer.

In various embodiments, following a user establishing a credit account with a gaming establishment credit system (i.e., a user applying for a marker (with or without presenting a check or other bank account information in the event the marker is not paid back by the user) and the credit system approving the marker for up to a set amount of funds), the system enables the user to utilize any suitable interface to view information about one or more available markers (e.g., an available amount of funds associated with the marker and/or an amount of funds associated with the marker previously accessed) as well as the balance of zero, one or more gaming establishment accounts. Additionally, the system enables a user to request an amount of funds to be drawn against such a gaming establishment marker utilizing the additional security measures provided via a separately operating marker approval device.

In certain embodiments, as part of requesting an amount of funds to be drawn against a gaming establishment marker, the system determines zero, one or more security measures to invoke in association with one or more (or each) transaction that involves funds accessed via the marker. In these embodiments, to prevent unauthorized access to the funds associated with such a marker, the system applies such determined security measures in association with one or more (or each) transaction that attempts to access funds via the marker. In certain embodiments, as part of requesting an amount of funds to be drawn against a gaming establishment marker, the system employs one or more security measures that involve a user's interaction with a marker approval device, such as a mobile device, that is different from the device at which the request originated from. That is, following a user's request to draw funds against a gaming establishment marker from a first device, such as from an EGM, the system employs a second device, such as an enrolled mobile device, to invoke additional security measures in association with the user's request. For example, following a user requesting, via a service window displayed by an EGM, an amount of funds from a gaming establishment marker, the credit system sends the user's enrolled mobile device (i.e., the marker approval device) a push notification to approve the requested marker. In this example, based on whether or not the user approves the requested marker from the enrolled mobile device determines, at least in part, whether or not the credit system completes the requested transaction.

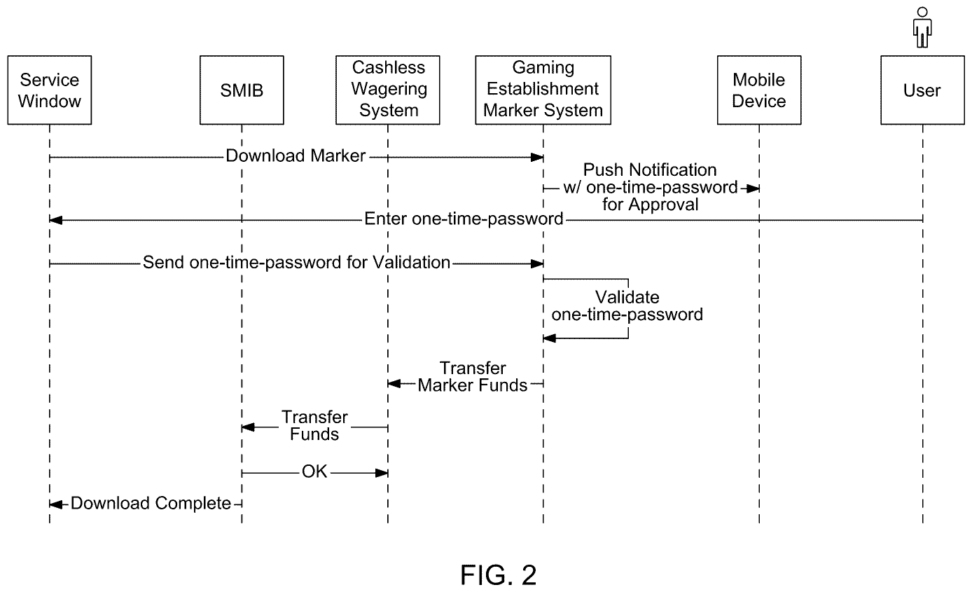

In certain embodiments, the security measure communicated to the marker approval device includes a limited duration security measure, such as a one-time-password. In these embodiments, following the credit system communicating the limited duration security measure to the marker approval device, the user submits the limited duration security measure (e.g., the one-time-password communicated to their mobile device) to the device where the transaction was initiated to confirm (or deny) the requested withdrawal of funds against the gaming establishment marker. For example, as seen in FIG. 2 (which illustrates the different interactions between the service window displayed by a gaming establishment device, the SMIB associated with the gaming establishment device, the cashless wagering system, the gaming establishment credit system, and a marker approval device taking the form of a user's mobile device), following a user requesting, via the service window displayed by the gaming establishment device, to draw an amount of funds against a marker (not shown), the gaming establishment credit system pushes a notification including a one-time-password to the user's mobile device. In this example, as an additional security measure invoked to access the funds from the marker, the system requires the user to enter the one-time-password into the displayed service window. Following the gaming establishment credit system validating the one-time-password, the gaming establishment credit system operates with the gaming establishment cashless system to transfer the requested amount of funds to a cashless wagering account of the user maintained by the cashless wagering system and then to the gaming establishment device where the request initiated from. In this example, if the gaming establishment credit system fails to validate the one-time-password, the gaming establishment credit system denies the request without drawing the requested funds against the gaming establishment marker.

In certain embodiments, the security measure communicated to the marker approval device includes one or more possession-based factors (i.e., information which the user and only the user should have) which the user submits to the device where the transaction was initiated to confirm (or deny) the requested withdrawal of funds against the gaming establishment marker. If the one or more components of the system fail to validate the possession-based factor security measure, the gaming establishment credit system denies the request without drawing the requested funds against the gaming establishment marker. On the other hand, in certain embodiments, following one or more components of the system validating the possession-based factor security measure, the gaming establishment credit system operates with a gaming establishment cashless system to transfer the amount of funds drawn against the gaming establishment marker to a cashless wagering account of the user maintained by the cashless wagering system and then to the gaming establishment device where the request initiated from. In other embodiments, following one or more components of the system validating the possession-based factor security measure, the gaming establishment credit system operates to transfer the requested amount of funds drawn against the gaming establishment marker directly to the gaming establishment device.

In certain embodiments, the invoked security measure communicated to the marker approval device includes one or more possession-based factors (e.g., a digital signature) which the user submits to the maker approval device (with or without further interactions with the device where the transaction was initiated) to confirm (or deny) the requested withdrawal of funds against the gaming establishment marker. In certain such embodiments, the security measure employed separate and apart from the device where the marker transaction was initiated includes the user approving the marker transaction via associating a digital signature with the marker transaction. In certain such embodiments, the user employs the marker approval device to electronically sign the request to draw funds against the gaming establishment marker to form the digital signature. In certain other embodiments, the system enables the user to access a signature already on file with the gaming establishment to guarantee the gaming establishment marker.

In certain embodiments, if the one or more components of the system fail to validate the digital signature, the gaming establishment credit system denies the request without drawing the requested funds against the gaming establishment marker. On the other hand, following one or more components of the system validating the digital signature, the credit system will record the validated digital signature as additional evidence of the user's intention to draw funds against the gaming establishment marker. In certain embodiments, following a validation of the digital signature, the gaming establishment credit system operates with a gaming establishment cashless system to transfer the amount of funds drawn against the gaming establishment marker to a cashless wagering account of the user maintained by the cashless wagering system and then to the gaming establishment device where the request initiated from. In other embodiments, following a validation of the digital signature, the gaming establishment credit system operates to transfer the requested amount of funds drawn against the gaming establishment marker directly to the gaming establishment device. It should be appreciated that such a configuration simulates the historic workflow where a user has to sign a receipt issued by the gaming establishment cage and table accounting system (i.e., a marker slip) for each drawdown on their marker by enabling the user to associate a digital signature with a digital marker slip to approve the marker transaction. Since a digital signature is significantly more difficult to forge on gaming establishment paperwork, employing digital signatures reduces instances of fraud when someone other than a user withdraws funds against a gaming establishment marker in the user's name (which may occur with the removal of gaming establishment personnel from the marker approval process).

In certain embodiments, the invoked security measure communicated to the marker approval device enables the approval of the security measure via the marker approval device without additional interactions with the gaming establishment device. In certain such embodiments, utilizing data obtained from the marker approval device, such as biometric data captured from a mobile device operating as a marker approval device, the system enables the user to approve the withdrawal of funds against the gaming establishment marker from the marker approval device. In these embodiments, the system employs one or more biometric-based factors (i.e., one or more biometric identifiers associated with the user, such as a scanned fingerprint, a recognized iris and/or an identified voice) to enhance the security associated with the user borrowing an amount of funds from the gaming establishment credit system. It should be appreciated that the use of the marker approval device to obtain data uniquely associated with a user, such as by tapping the biometric capturing capabilities associated with a mobile device trusted to authenticate the user (i.e., a mobile device running an application configured with FaceID, or other suitable authentication technologies), enables the user to approve the requested transaction with no need for the user to further interact with the gaming establishment device.

It should be appreciated that if one or more biometric-based factors are utilized, to capture one or more biometric identifiers, the marker approval device includes various biometric detecting devices configured to detect individualized biometrics of a user. In one such embodiment, the marker approval device includes a fingerprint detector configured to read a fingerprint of a user. In another such embodiment, the marker approval device includes a retinal scanner configured to scan a user's retinas. In another such embodiment, the marker approval device includes a facial recognition device configured to recognize a user's face. In different embodiments, any suitable hardware, such as cameras and microphones, and specialized software can be used to capture or measure any identifying information of a user, such as but not limited to, vein detection in palms or other body components, voice recognition, handwriting analysis, keyboard or other input styles and tendencies, eye pattern movements, shapes of fingers, hands or other body parts, thermal patterns, and/or blood pressure.

Accordingly, in certain embodiments in which the gaming establishment device is an electronic gaming machine, responsive to a request, made from the electronic gaming machine, to draw an amount of funds against a gaming establishment marker associated with a user, the system communicates data associated with a security measure to a marker approval device associated with the user. The marker approval device of these embodiments operates independent of a processor of the system and independent of the electronic gaming machine. Additionally and responsive to a satisfaction of the security measure at least partially based on an interaction, by the user, with the marker approval device, the system approves the request to draw the amount of funds against the gaming establishment marker, and causes a transfer of the amount of funds to a credit balance of the electronic gaming machine.

In certain other embodiments in which the gaming establishment device is a gaming table component associated with a gaming table, responsive to a receipt of data associated with a request to draw an amount of funds against a gaming establishment marker associated with a user at the gaming table, the system communicates data associated with a security measure to a marker approval device associated with the user. In these embodiments, the marker approval device operates independent of a processor of the system and independent of the gaming table component. Responsive to a satisfaction of the security measure at least partially based on an interaction, by the user, with the marker approval device, the system approves the request to draw the amount of funds against the gaming establishment marker, and causes the amount of funds to be made available to the user at the gaming table.

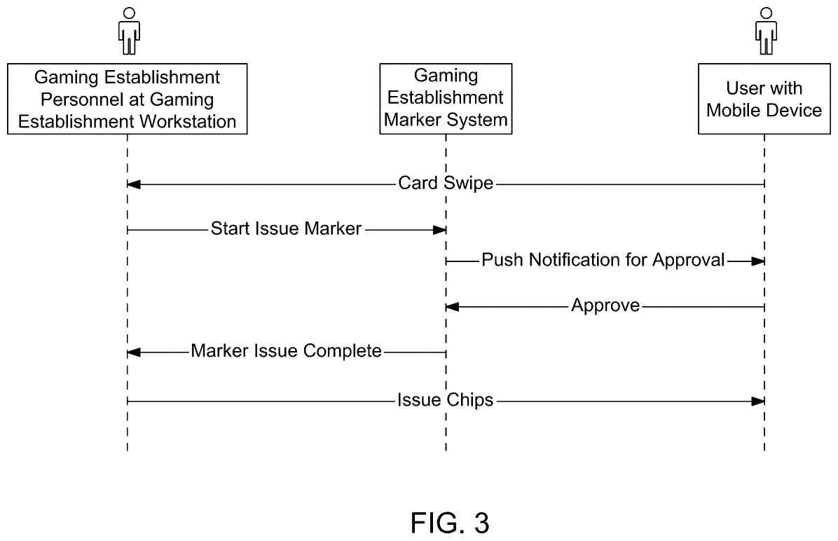

It should be appreciated that while described above in relation to the marker transaction being initiated from a gaming establishment device by a user, in certain alternative embodiments, the marker transfer is initiated independent of the user, but subsequently approved by the user via the marker approval device. In these embodiments, an actor independent of the user, such as a member of gaming establishment personnel, take one or more actions to request a withdrawal of an amount of funds against a marker associated with a user. Following such a request initiated by a third-party, the system employs one or more of the security measures of the present disclosure to enable the user to approve (or deny) the attempted marker transaction. For example, as seen in FIG. 3 (which illustrates the different interactions between a member of gaming establishment personnel at a gaming establishment personnel workstation, the gaming establishment credit system, and a marker approval device taking the form of a user's mobile device), following a member of gaming establishment personnel initiating a marker transaction on behalf of a user by swiping an identifier, such as a player tracking card issued by a player tracking system, associated with the user at the gaming establishment personnel workstation, the gaming establishment marker system pushes one or more of the additional security measures (e.g., a biometric-based factor and/or a possession-based factor) to the user's mobile device. In this example, the system requires the user to satisfy such security measures(s) to approve (or deny) drawing an amount of funds against the marker. Following the gaming establishment credit system validating that the user satisfied the security measures using their mobile device, the gaming establishment credit system operates to complete the marker transaction and alert the member of gaming establishment personnel to dispense an amount of gaming table chips to the user. On the other hand, if the gaming establishment credit system fails to validate that the user satisfied the security measures using their mobile device, the gaming establishment credit system denies the marker transaction without drawing any funds against the gaming establishment marker.

Accordingly, in certain embodiments and responsive to a receipt, from a third-party device independent of any gaming establishment device associated with a user, of data associated with a request to draw an amount of funds against a gaming establishment marker associated with the user, the system communicates data associated with a security measure to a marker approval device associated with the user. The marker approval device of these embodiments operates independent of a processor of the system and independent of the third-party device. Moreover, responsive to a satisfaction of the security measure at least partially based on an interaction, by the user, with the marker approval device, the system approves the request to draw the amount of funds against the gaming establishment marker, and causes the amount of funds to be made available to the user.

In certain embodiments in which funds accessed from a gaming establishment marker are indirectly transferred to a gaming establishment device, following receipt of the user inputted data associated with the determined amount of funds to be accessed via the marker and a confirmation, via the independently operating marker approval device, from the user that they approve of the transaction, the gaming establishment credit system logs the user into the gaming establishment credit system (if necessary) and attempts to verify an activation of the amount of funds to be accessed via the marker of the user. Upon verifying the activation, the gaming establishment credit system proceeds with operating with the gaming establishment fund management system (e.g., a gaming establishment cashless wagering system) to log the user into a gaming establishment account, such as, but not limited to a cashless wagering account, associated with the user (if necessary) and potentially transfer the amount of funds to be accessed via the marker to the gaming establishment account associated with the user (e.g., to a gaming establishment cashless wagering account associated with the user.)

In operation of such embodiments, after confirming that the security measures invoked using the marker approval device have been satisfied, to complete a transfer of an amount of funds accessed via a marker to a gaming establishment account, the gaming establishment credit system determines whether to authorize the activation of the determined amount of funds. In these embodiments, if the gaming establishment credit system determines not to authorize the activation of the determined amount of funds via the marker, the gaming establishment credit system communicates one or more denial messages. In certain embodiments, following the denial, one or more display devices (e.g., display devices of a mobile device and/or the gaming establishment device) display a denial of marker activation to the user.

On the other hand, if the gaming establishment credit system determines to authorize the activation of the determined amount of funds via the marker, the gaming establishment credit system updates the amount provided via the marker and communicates an authorization of the requested amount of funds to the gaming establishment fund management system. Upon receiving the authorization, the gaming establishment fund management system updates a balance of a gaming establishment account by the requested amount of funds activated via the marker. In certain embodiments, in association with the transfer, the system communicates a transfer of funds confirmation, wherein one or more display devices display a confirmation of the transfer of the amount of funds from the marker to the gaming establishment account.

In certain embodiments, following the completion of the transfer of an amount of funds associated with the marker to the gaming establishment account, such as a cashless wagering account associated with a user, the system enables the user to transfer an amount of funds from the gaming establishment account to the gaming establishment device where the request originated from. In certain embodiments, this transfer occurs in association with the gaming establishment device and/or a mobile device paired with (or otherwise operable to identify) the gaming establishment device. In certain other embodiments, following the completion of the transfer of an amount of funds associated with the marker to the gaming establishment account, such as a cashless wagering account associated with a user, the system automatically initiates a transfer of an amount of funds from the gaming establishment account to the gaming establishment device where the request originated from. In these embodiments, rather than the user making one or more inputs to attempt to transfer the amount of funds accessed via the marker to the gaming establishment device, the system automatically determines to transfer an amount of funds, such as the amount accessed via the marker, from the gaming establishment account to the gaming establishment device.

In these different embodiments, following a determination to transfer an amount of funds from the gaming establishment account to the gaming establishment device where the request originated from, a component of the gaming establishment fund management system, such as a server of the cashless wagering system, logs the user into a gaming establishment account associated with the user (if necessary) and requests the determined amount of funds to be transferred from the gaming establishment account to the gaming establishment device where the request originated from. In these embodiments, the component of the gaming establishment fund management system, such as a server of the cashless wagering system, determines whether to authorize the transfer of the amount of funds. If the component of the gaming establishment fund management system determines not to authorize the determined amount of funds, the component of the gaming establishment fund management system communicates a denial and, in certain embodiments, displays a denial of funds transfer to the user. On the other hand, if the component of the gaming establishment fund management system determines to authorize the amount of funds, the component of the gaming establishment fund management system updates the gaming establishment account associated with the user and communicates an authorization to the gaming establishment device. For example, when funds are transferred from a cashless wagering account to an EGM, the cashless wagering system reduces a balance of the cashless wagering account by the reduced amount of funds. The EGM (or a SMIB associated with the EGM) proceeds with updating a credit balance of the EGM to account for the amount of funds. In certain embodiments, the EGM further proceeds with communicating a transfer of funds confirmation and such a transferred amount of funds are then available for wagering at the EGM.

In certain embodiments in which funds accessed from a gaming establishment marker are directly transferred to a gaming establishment device, following receipt of the user inputted data associated with the determined amount of funds to be accessed via the marker and a confirmation, via the independently operating marker approval device, from the user that they approve of the transaction, the gaming establishment credit system logs the user into the gaming establishment credit system (if necessary) and attempts to verify an activation of the amount of funds to be accessed via the marker of the user. Upon verifying the activation, the gaming establishment credit system proceeds with operating with the gaming establishment device to transfer such funds to the gaming establishment device. In operation of such embodiments, after confirming that the security measures invoked using the marker approval device have been satisfied, to complete a transfer of an amount of funds accessed via a marker to a gaming establishment account, the gaming establishment credit system determines whether to authorize the activation of the determined amount of funds.

In these embodiments, if the gaming establishment credit system determines not to authorize the activation of the determined amount of funds via the marker, the gaming establishment credit system communicates one or more denial messages. In certain embodiments, following the denial, one or more display devices (e.g., display devices of a mobile device and/or the gaming establishment device) display a denial of marker activation to the user. On the other hand, if the gaming establishment credit system determines to authorize the activation of the determined amount of funds via the marker, the gaming establishment credit system updates the amount provided via the marker and initiates a transfer of an amount of funds to the gaming establishment device where the request originated from. For example, when funds drawn against a gaming establishment marker are transferred to an EGM, the gaming establishment credit system updates one or more databases to reflect the current debt associated with the gaming establishment marker and the EGM (or a SMIB associated with the EGM) proceeds with updating a credit balance of the EGM to account for the amount of funds (which are then available for wagering at the EGM).

It should be appreciated that in addition to employing a marker approval device to approve a marker transaction including a transfer of funds activated via a marker from a gaming establishment credit system to a gaming establishment device (directly or indirectly via a gaming establishment account), the system enables the employment of a marker approval device to approve a marker transaction including a transfer of funds from a gaming establishment device to a gaming establishment credit system (directly or indirectly via a gaming establishment account) to payback or otherwise deactivate a marker. In these embodiments, following a request to retire part or all of an amount of outstanding funds associated with a gaming establishment marker, the system employs one or more of the additional security measures (e.g., a biometric-based factor and/or a possession-based factor) to potentially be satisfied using a marker approval device, such as a mobile device. In such embodiments, the system requires the user to satisfy such security measures(s) to approve (or deny) repaying part or all of an amount of funds drawn against the marker.

Accordingly, in view of certain security risks associated with a user accessing a gaming establishment marker with limited or no interaction with gaming establishment personnel to, amongst other actions, confirm the identity of the user and confirm the user wants to proceed with a transaction involving drawing funds against a gaming establishment marker, the system employs a distinct marker approval device (e.g., a mobile device), and in certain embodiments, the ability of the marker approval device to capture biometric data associated with a user, to introduce an additional layer of authentication to how a user interacts with one or more components of a gaming establishment credit system. That is, utilizing data obtained from a separate marker approval device, such as a limited duration approval and/or biometric data captured from the mobile device, enables the system to enhance security and ease of use in how users are identified and authenticated in accessing funds from a gaming establishment marker. When compared to certain authentication methods which rely on simply a username and password, employing such a distinct marker approval device (and zero, one or more limited duration approvals and/or biometric data obtained from that marker approval device) provides a relatively safer and more secure way to authenticate and authorize a gaming establishment credit transaction in a gaming environment.

Additionally, employing the marker approval device enables an electronic transfer of funds from a gaming establishment credit system directly or indirectly to a balance of a gaming establishment device (e.g., an EGM) without the use of cash and without losing any security functionality otherwise associated with gaming establishment markers. Put differently, since certain gaming establishment patrons are uncomfortable venturing into a gaming establishment with large amounts of cash, the system enables a user access to an amount of funds from a gaming establishment marker without the need to handle cash. Such a reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Moreover, by reducing the amount of cash transactions in a gaming establishment via enabling the use of gaming establishment markers while retaining security functionality through the employment of a separately operating marker approval device, the system reduces or eliminates human errors which often occur when gaming table chips, cash and/or cashless ticket vouchers are distributed at gaming establishment interfaces, such as casino desks in association with the activation of a gaming establishment marker. Specifically, eliminating gaming establishment personnel from distributing gaming table chips, cash and/or cashless ticket vouchers in association with the activation of a gaming establishment marker not only protects the user (if the gaming establishment personnel provides the gaming establishment patron a lower amount of gaming table chips, cash and/or a lower valued cashless ticket voucher than the patron deserves) but also protects the gaming establishment (if the gaming establishment personnel inadvertently or fraudulently provides the patron a higher amount of gaming table chips, cash and/or or a higher valued cashless ticket voucher than the patron deserves). As such, the system of the present disclosure provides an alternative, non-cash-based and non-ticket voucher-based option for a gaming establishment patron to safely access funds drawn from a gaming establishment marker at a gaming establishment device while minimizing (or eliminating) certain human errors.

It should be appreciated that any functionality or process of the present disclosure may be implemented via one or more components of a gaming establishment system (e.g., a server of a gaming establishment credit system and/or a server of a gaming establishment fund management system), one or more gaming establishment devices (e.g., a gaming device such as an EGM or a gaming table component or a non-gaming device such as a gaming establishment personnel workstation), one or more components associated with a gaming establishment device (such as a SMIB or other component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device, such functions, features or processes may alternatively be performed by one or more components associated with the gaming establishment device, one or more components of a gaming establishment system, or one or more mobile device applications, (ii) while certain functions, features or processes are described herein as being performed by a component associated with a gaming establishment device, such functions, features or processes may alternatively be performed by one or more gaming establishment devices, one or more components of a gaming establishment system, or one or more mobile device applications, (iii) while certain functions, features or processes are described herein as being performed by one or more mobile device applications, such functions, features or processes may alternatively be performed by one or more components of a gaming establishment system, one or more gaming establishment devices, or one or more components associated with a gaming establishment device, and/or (iv) while certain functions, features or processes are described herein as being performed by one or more components of a gaming establishment system, such functions, features or processes may alternatively be performed by one or more gaming establishment devices, one or more components associated with a gaming establishment device, or one or more mobile device applications.

In certain embodiments, the above-described embodiments of the present disclosure may be implemented in accordance with or in conjunction with zero, one or more gaming establishment devices (e.g., an EGM, or a gaming table component); zero, one or more components associated with a gaming establishment device (e.g., a SMIB associated with an EGM) and/or zero, one or more components of a gaming establishment system (e.g., a server of a gaming establishment credit system and/or a server of a gaming establishment fund management system). In these embodiments, such devices and components each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the gaming establishment device, the component associated with the gaming establishment device, and/or the component of the gaming establishment system; (3) accessing memory to configure or reconfigure parameters in the memory according to indicia read from the gaming establishment device, the component associated with the gaming establishment device, and/or the component of the gaming establishment system; (4) communicating with interfaces and the peripheral devices (such as input/output devices); and/or (5) controlling the peripheral devices. In certain embodiments, one or more components of the controller (such as the at least one processor) reside within a housing of the gaming establishment device, the component associated with the gaming establishment device, and/or the component of the gaming establishment system, while in other embodiments, at least one component of the controller resides outside of the housing of the gaming establishment device, the component associated with the gaming establishment device, and/or the component of the gaming establishment system.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the gaming establishment device, the component associated with the gaming establishment device, and/or the component of the gaming establishment system. In certain embodiments, the at least one memory device resides within the housing of the gaming establishment device, the component associated with the gaming establishment device, and/or the component of the gaming establishment system, while in other embodiments at least one component of the at least one memory device resides outside of the housing of the gaming establishment device, the component associated with the gaming establishment device, and/or the component of the gaming establishment system. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the gaming establishment device, the component associated with the gaming establishment device, and/or the component of the gaming establishment system; (2) associations between configuration indicia read from the gaming establishment device, the component associated with the gaming establishment device, and/or the component of the gaming establishment system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/ 2, HomeRF, etc.) configured to enable the gaming establishment device, the component associated with the gaming establishment device, and/or the component of the gaming establishment system to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the gaming establishment device, the component associated with the gaming establishment device, and/or the component of the gaming establishment system to control the gaming establishment device, the component associated with the gaming establishment device, and/or the component of the gaming establishment system. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user employs such a removable memory device in a component of the gaming establishment system to implement at least part of the present disclosure. In other embodiments, part or all of the program code and/or the operating data is downloaded to the at least one memory device of the gaming establishment device, the component associated with the gaming establishment device, and/or the component of the gaming establishment system through any suitable data network described above (such as an Internet or intranet).

The at least one memory device also stores a plurality of device drivers. Examples of different types of device drivers include device drivers for the gaming establishment device, the component associated with the gaming establishment device, and/or the component of the gaming establishment system and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the gaming establishment device, the component associated with the gaming establishment device, and/or the component of the gaming establishment system. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the gaming establishment device, the component associated with the gaming establishment device, and/or the component of the gaming establishment system loads the new device driver from the at least one memory device to enable communication with the new device. For instance, one type of card reader in the gaming establishment device, the component associated with the gaming establishment device, and/or the component of the gaming establishment system can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the gaming establishment device, the component associated with the gaming establishment device, and/or the component of the gaming establishment system and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the gaming establishment device, the component associated with the gaming establishment device, and/or the component of the gaming establishment system. In various embodiments, the display devices serve as digital glass configured to aspects of the gaming establishment in which the gaming establishment device, the component associated with the gaming establishment device, and/or the component of the gaming establishment system is located. In various embodiments, the gaming establishment device, the component associated with the gaming establishment device, and/or the component of the gaming establishment system includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the gaming establishment device, the component associated with the gaming establishment device, and/or the component of the gaming establishment system receives an actuation, the gaming establishment device, the component associated with the gaming establishment device, and/or the component of the gaming establishment system causes the payout device to provide a payment to the user. In certain embodiments, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the gaming establishment device, the component associated with the gaming establishment device, and/or the component of the gaming establishment system provides dynamic sounds coupled with attractive multimedia images displayed on one or more of the display devices to provide an audio-visual representation or to otherwise display full-motion video with sound to attract users to the gaming establishment device, the component associated with the gaming establishment device, and/or the component of the gaming establishment system. In certain embodiments, the gaming establishment device, the component associated with the gaming establishment device, and/or the component of the gaming establishment system displays a sequence of audio and/or visual attraction messages during idle periods to attract potential users to the gaming establishment device, the component associated with the gaming establishment device, and/or the component of the gaming establishment system. The videos may be customized to provide any appropriate information.

The at least one input device may include any suitable device that enables an input signal to be produced and received by the at least one processor of the gaming establishment device, the component associated with the gaming establishment device, and/or the component of the gaming establishment system. In one embodiment, the at least one input device includes a payment device configured to communicate with the at least one processor of the gaming establishment device, the component associated with the gaming establishment device, and/or the component of the gaming establishment system to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the gaming establishment device, the component associated with the gaming establishment device, and/or the component of the gaming establishment system operator to, when actuated, cause the gaming establishment device, the component associated with the gaming establishment device, and/or the component of the gaming establishment system to perform particular functions. For instance, such buttons may be hard keys, programmable soft keys, or icons icon displayed on a display device of the gaming establishment device, the component associated with the gaming establishment device, and/or the component of the gaming establishment system that are actuatable via a touch screen of the gaming establishment device, the component associated with the gaming establishment device, and/or the component of the gaming establishment system or via use of a suitable input device of the gaming establishment device, the component associated with the gaming establishment device, and/or the component of the gaming establishment system. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device, the component associated with the gaming establishment device, and/or the component of the gaming establishment system by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the gaming establishment device, the component associated with the gaming establishment device, and/or the component of the gaming establishment system. In one embodiment, a user input device docking region is provided, and includes a power distribution component that is configured to recharge a user input device without requiring metal-to-metal contact. In one embodiment, the at least one power distribution component is configured to distribute power to one or more internal components of the gaming establishment device, the component associated with the gaming establishment device, and/or the component of the gaming establishment system, such as one or more rechargeable power sources (e.g., rechargeable batteries) located at the gaming establishment device, the component associated with the gaming establishment device, and/or the component of the gaming establishment system.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the gaming establishment device, the component associated with the gaming establishment device, and/or the component of the gaming establishment system; detecting the presence and/or identity of various persons (e.g., users, casino employees, etc.), devices (e.g., user input devices), and/or systems within a predetermined proximity to the gaming establishment device, the component associated with the gaming establishment device, and/or the component of the gaming establishment system.

The at least one data preservation component is configured to detect or sense one or more events and/or conditions that, for example, may result in damage to the gaming establishment device, the component associated with the gaming establishment device, and/or the component of the gaming establishment system and/or that may result in loss of information associated with the gaming establishment device, the component associated with the gaming establishment device, and/or the component of the gaming establishment system. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the gaming establishment device, the component associated with the gaming establishment device, and/or the component of the gaming establishment system to operate in a mobile environment.

The at least one geolocation module is configured to acquire geolocation information from one or more remote sources and use the acquired geolocation information to determine information relating to a relative and/or absolute position of the gaming establishment device, the component associated with the gaming establishment device, and/or the component of the gaming establishment system. For example, in one implementation, the at least one geolocation module is configured to receive GPS signal information for use in determining the position or location of the gaming establishment device, the component associated with the gaming establishment device, and/or the component of the gaming establishment system. In another implementation, the at least one geolocation module is configured to receive multiple wireless signals from multiple remote devices (e.g., the gaming establishment device, the component associated with the gaming establishment device, and/or the component of the gaming establishment system, wireless access points, etc.) and use the signal information to compute position/location information relating to the position or location of the gaming establishment device, the component associated with the gaming establishment device, and/or the component of the gaming establishment system.

The at least one user identification module is configured to determine the identity of the current user or current owner of the gaming establishment device, the component associated with the gaming establishment device, and/or the component of the gaming establishment system. For example, in one embodiment, the current user is required to perform a login process at the gaming establishment device, the component associated with the gaming establishment device, and/or the component of the gaming establishment system in order to access one or more features. Alternatively, the gaming establishment device, the component associated with the gaming establishment device, and/or the component of the gaming establishment system is configured to automatically determine the identity of the current user based on one or more external signals, such as an RFID tag or badge worn by the current user and that provides a wireless signal to the gaming establishment device, the component associated with the gaming establishment device, and/or the component of the gaming establishment system that is used to determine the identity of the current user. In at least one embodiment, various security features are incorporated into the gaming establishment device, the component associated with the gaming establishment device, and/or the component of the gaming establishment system to prevent unauthorized users from accessing confidential or sensitive information.

The at least one information filtering module is configured to perform filtering (e.g., based on specified criteria) of selected information to be displayed at one or more displays of the gaming establishment device, the component associated with the gaming establishment device, and/or the component of the gaming establishment system.

In various embodiments, the gaming establishment device, the component associated with the gaming establishment device, and/or the component of the gaming establishment system includes a plurality of communication ports configured to enable the at least one processor of the gaming establishment device, the component associated with the gaming establishment device, and/or the component of the gaming establishment system to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the gaming establishment device, the component associated with the gaming establishment device, and/or the component of the gaming establishment system has a support structure, housing, or cabinet that provides support for a plurality of the input devices and the output devices of the gaming establishment device, the component associated with the gaming establishment device, and/or the component of the gaming establishment system.

It should be appreciated that in certain instances in which the gaming establishment device is an EGM, such an EGM includes certain components and/or are configured to operate in certain manners that differentiate these systems from general purpose computing devices. For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

It should be further appreciated that while one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor (i.e., a master gaming controller) running instructions to provide the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general-purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

1. A system comprising:
a processor; and
a memory device that stores a plurality of instructions that, when executed by the processor responsive to a receipt, from a third-party device independent of any gaming establishment device associated with a user, of data associated with a request to draw an amount of funds against a gaming establishment marker associated with the user, cause the processor to:
communicate data associated with a security measure to a marker approval device associated with the user, the marker approval device operating independent of the processor and independent of the third-party device, and
responsive to a satisfaction of the security measure at least partially based on an interaction, by the user, with the marker approval device:
approve the request to draw the amount of funds against the gaming establishment marker, and
cause the amount of funds to be made available to the user.

2. The system of claim 1, wherein the third-party device comprises a gaming establishment personnel workstation.

3. The system of claim 1, wherein the data associated with the request to draw the amount of funds against the gaming establishment marker associated with the user comprises data identifying the user by a gaming establishment patron management system.

4. The system of claim 1, wherein a gaming establishment device associated with the user comprises any of an electronic gaming machine at which the user is logged in and a gaming table component at which the user is logged in.

5. The system of claim 1, wherein the satisfaction of the security measure occurs independent of the third-party device.

6. The system of claim 5, wherein the satisfaction of the security measure comprises biometric data associated with the user being received by the marker approval device.

7. The system of claim 5, wherein the satisfaction of the security measure comprises a digital signature associated with the user being received by the marker approval device.

8. The system of claim 1, wherein causing the amount of funds to be made available to the user occurs in association with a transfer of the amount of funds to a gaming establishment account maintained by a component of a gaming establishment fund management system followed by an automatic transfer of the amount of funds from the gaming establishment account.

9. A system comprising:
a processor; and
a memory device that stores a plurality of instructions that, when executed by the processor responsive to a receipt, from a third-party device independent of any gaming establishment device associated with a user, of data associated with a request to draw an amount of funds against a gaming establishment marker associated with the user, cause the processor to:
communicate, to a marker approval device associated with the user, data associated with a security measure associated with a limited duration of time, the marker approval device operating independent of the processor and independent of the third-party device,
responsive to a satisfaction of the security measure within the limited duration of time and at least partially based on an interaction, by the user, with the marker approval device:
approve the request to draw the amount of funds against the gaming establishment marker, and
cause the amount of funds to be made available to the user, and
responsive to the satisfaction of the security measure outside the limited duration of time, deny the request to draw the amount of funds against the gaming establishment marker.

10. The system of claim 9, wherein the third-party device comprises a gaming establishment personnel workstation.

11. The system of claim 10, wherein the data received from the third-party device comprises data inputted by gaming establishment personnel.

12. The system of claim 9, wherein causing the amount of funds to be made available to the user occurs in association with a transfer of the amount of funds to a gaming establishment account maintained by a component of a gaming establishment fund management system followed by an automatic transfer of the amount of funds from the gaming establishment account.

13. A method of operating a system, the method comprising:
responsive to a receipt, from a third-party device independent of any gaming establishment device associated with a user, of data associated with a request to draw an amount of funds against a gaming establishment marker associated with the user:
communicating data associated with a security measure to a marker approval device associated with the user, the marker approval device operating independent of the processor and independent of the third-party device, and
responsive to a satisfaction of the security measure at least partially based on an interaction, by the user, with the marker approval device:
approving, by a processor, the request to draw the amount of funds against the gaming establishment marker, and
causing, by the processor, the amount of funds to be made available to the user.

14. The method of claim 13, wherein the third-party device comprises a gaming establishment personnel workstation.

15. The method of claim 13, wherein the data associated with the request to draw the amount of funds against the gaming establishment marker associated with the user comprises data identifying the user by a gaming establishment patron management system.

16. The method of claim 13, wherein a gaming establishment device associated with the user comprises any of an electronic gaming machine at which the user is logged in and a gaming table component at which the user is logged in.

17. The method of claim 13, wherein the satisfaction of the security measure occurs independent of the third-party device.

18. The method of claim 17, wherein the satisfaction of the security measure comprises biometric data associated with the user being received by the marker approval device.

19. The method of claim 17, wherein the satisfaction of the security measure comprises a digital signature associated with the user being received by the marker approval device.

20. The method of claim 13, wherein causing the amount of funds to be made available to the user occurs in association with a transfer of the amount of funds to a gaming establishment account maintained by a component of a gaming establishment fund management system followed by an automatic transfer of the amount of funds from the gaming establishment account.
